(19) United States
(12) Patent Application Publication
(10) Pub. No.: US 2026/0299688 A1
(43) Pub. Date: Oct. 1, 2026

(54) SYSTEM AND METHOD FOR BIOSIGNAL DATA TRANSFORMATION

(71) Applicant: Emotiv Inc., San Francisco, CA (US)

(72) Inventors: Geoffrey Ross Mackellar, Sydney (AU); Navid Mohammadi Foumani, Melbourne (AU); Jiazhen Hong, San Francisco, CA (US); Soheila GhaneEzabadi, Melbourne (AU); Nam Nguyen, North Sydney (AU)

(73) Assignee: Emotiv Inc., San Francisco, CA (US)

(21) Appl. No.: 19/636,528

(22) Filed: Apr. 1, 2026

Related U.S. Application Data
(60) Provisional application No. 63/781,577, filed on Apr. 1, 2025.
(60) Provisional application No. 63/781,592, filed on Apr. 1, 2025.
(60) Provisional application No. 63/850,383, filed on Jul. 24, 2025.
(60) Provisional application No. 63/899,033, filed on Oct. 14, 2025.

(51) Int. Cl. G06F 3/01

(52) U.S. Cl. CPC G06F 3/015

(57) ABSTRACT

The method includes determining biosignal data, determining an input representation for the biosignal data, and determining a brain state representation using the input representation. The method can additionally and optionally include determining supplemental information, training a representation model, determining a biomarker value based on the brain state representation, and/or any other suitable steps.

### CROSS-REFERENCE TO RELATED APPLICATIONS

This application claims the benefit of U.S. Provisional Application No. 63/781,577 filed 1 Apr. 2025, U.S. Provisional Application No. 63/781,592 filed 1 Apr. 2025, U.S. Provisional Application No. 63/850,383 filed 24 Jul. 2025, and U.S. Provisional Application No. 63/899,033 filed 14 Oct. 2025, each of which is incorporated in its entirety by this reference.

### TECHNICAL FIELD

This invention relates generally to the biosignal data analysis field, and more specifically to a new and useful system and method in the biosignal data analysis field.

### BRIEF DESCRIPTION OF THE SEVERAL VIEWS OF THE DRAWINGS

FIG. 1 is a schematic representation of a variant of the system.

FIG. 2 is a schematic representation of a variant of the system.

FIG. 3A is a schematic representation of an example of determining a brain state representation using a trained representation model.

FIG. 3B is a schematic representation of an example of determining a brain state representation using a trained input model and a trained representation model.

FIG. 4A is a schematic representation of an example of training a representation model (e.g., the representation model depicted in FIG. 3A).

FIG. 4B is a schematic representation of an example of training a representation model (e.g., the representation model depicted in FIG. 3B) and/or an input model (e.g., the input model depicted in FIG. 3B).

FIG. 5A depicts a first specific example of training a representation model.

FIG. 5B depicts a second specific example of training a representation model.

FIG. 6A depicts a third specific example of training a representation model.

FIG. 6B depicts a fourth specific example of training a representation model.

FIG. 7 depicts a specific example of an input model (e.g., a spatial-adaptive input embedding) that projects biosignal data to a target space (e.g., using 325 spatial weights derived from relative 3D coordinates).

FIG. 8 depicts a specific example of a Mamba2 block in a representation model.

FIG. 9 depicts an illustrative example of determining an input representation based on quantile features.

FIG. 10 depicts a specific example of the method, including using different biosignal devices (e.g., with different numbers of channels, with different sensor positioning, etc.).

### DETAILED DESCRIPTION OF THE INVENTION

The following description of the embodiments of the invention is not intended to limit the invention to these embodiments, but rather to enable any person skilled in the art to make and use this invention.

### 1. OVERVIEW

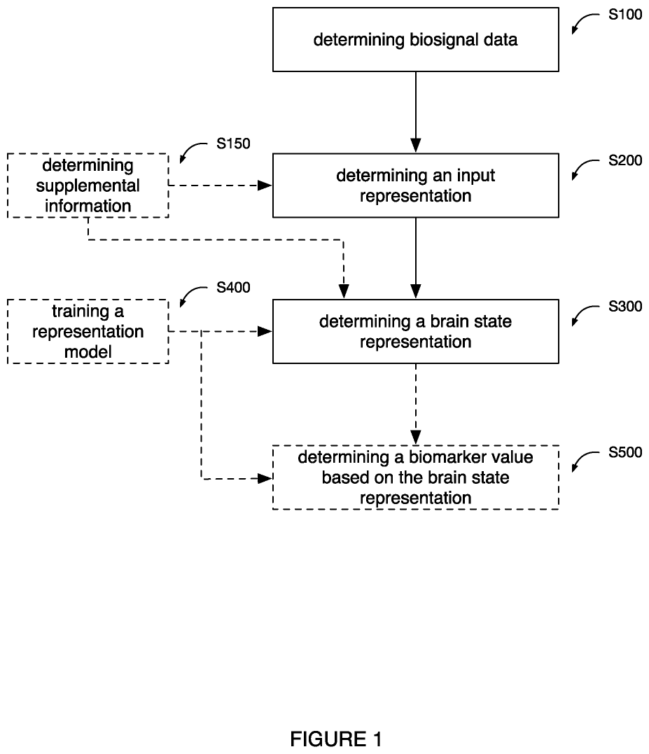

As shown in FIG. 1, the method can include: determining biosignal data S100, determining an input representation S200, and determining a brain state representation S300. The method can optionally include determining supplemental information S150, training a representation model S400, determining a biomarker value based on the brain state representation S500, and/or any other suitable steps.

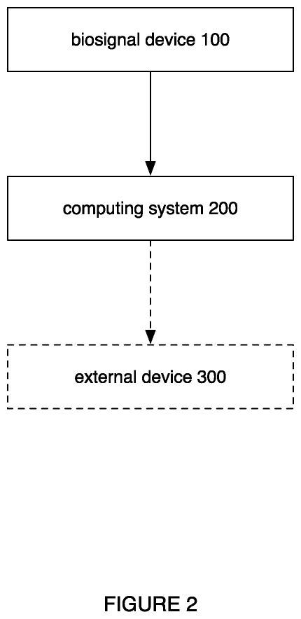

As shown in FIG. 2, the system can include: a biosignal device 100 and a computing system 200. However, the system can additionally or alternatively include any other suitable components.

In variants, the system and/or method can function to transform neurological biosignals into an embedding for determining a brain state of a user. Additionally or alternatively, the system and/or method can function to train a generalizable representation model for transforming neurological biosignal data (e.g., EEG data).

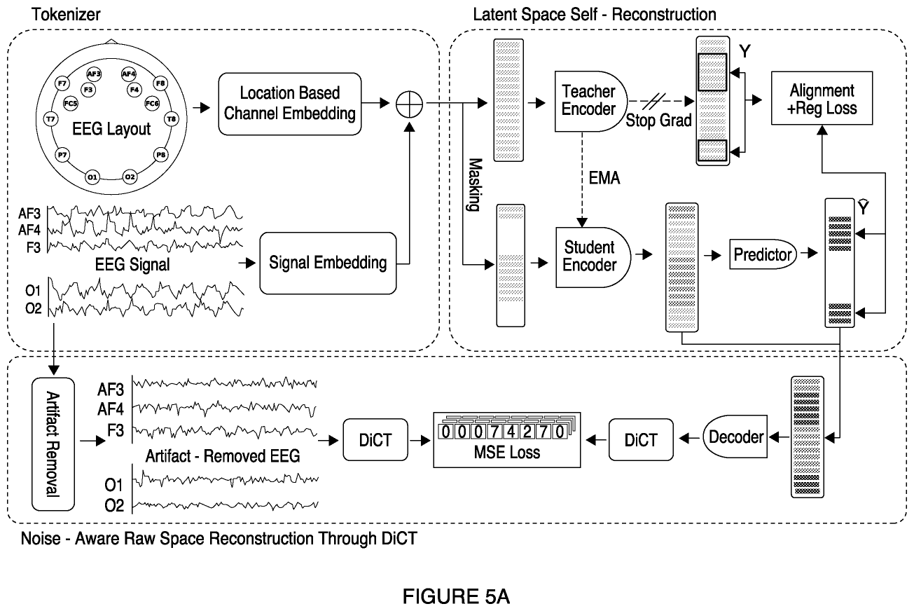

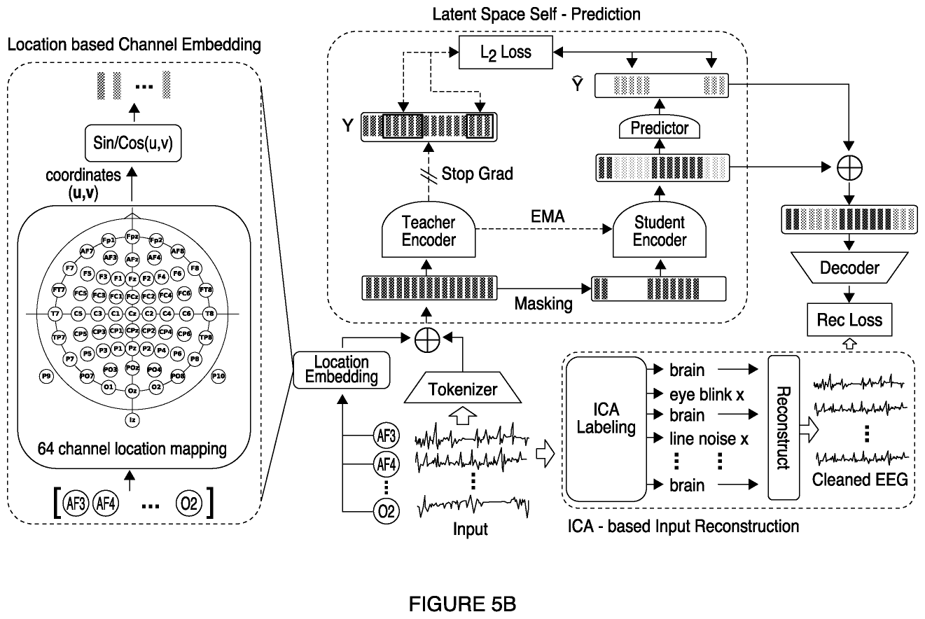

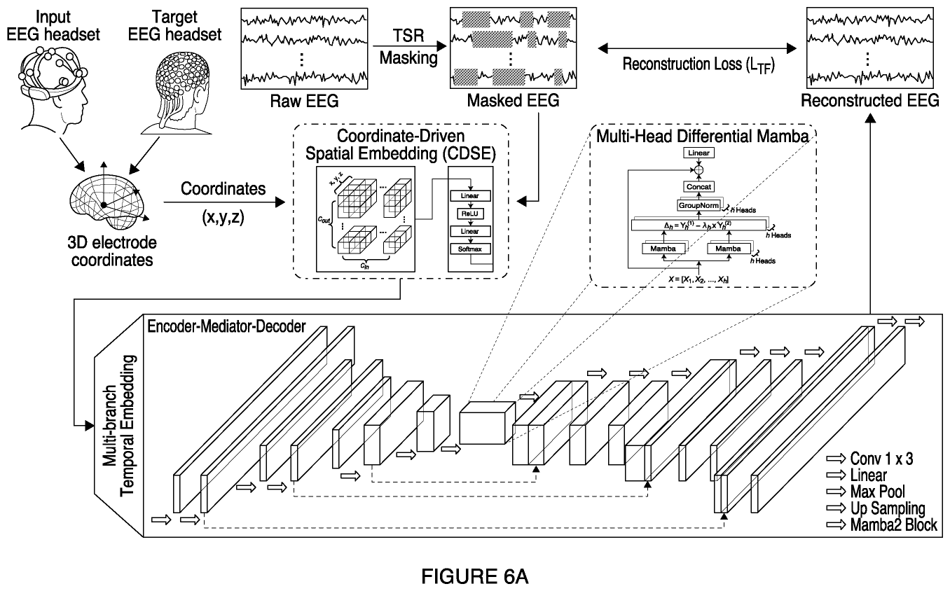

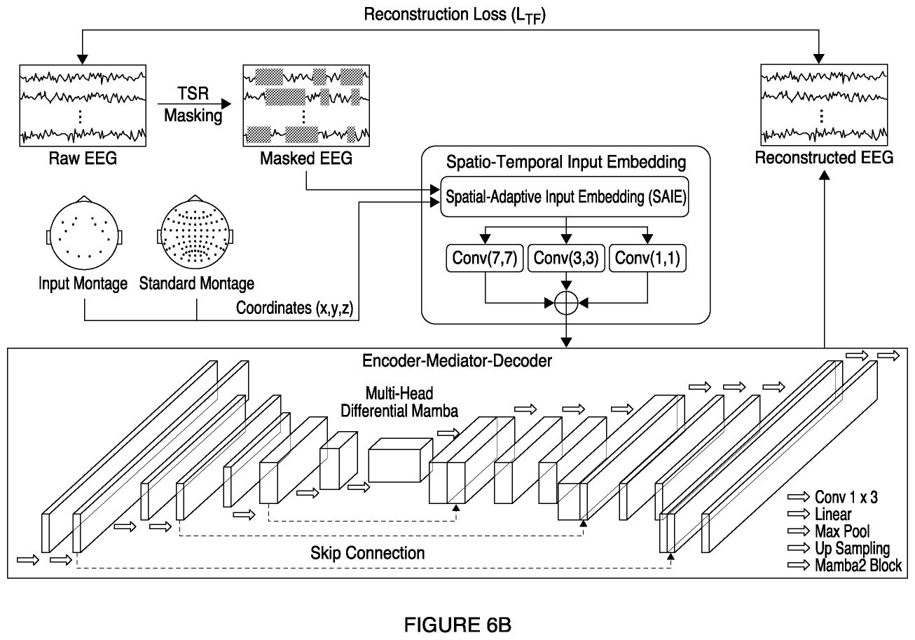

In an illustrative example, one or more input models can transform biosignal data (e.g., EEG data) and sensor location information (e.g., sensor coordinates) into an input embedding (e.g., a location embedding combined with tokenized biosignal data, a spatial-adaptive input embedding, a spatio-temporal input embedding determined based on the spatial-adaptive input embedding, etc.), and a representation model can transform the input embedding into a brain state representation. In a first example, the representation model can include an attention-based model (also referred to as an attention model such as a transformer encoder, a joint-embedding predictive architecture including attention blocks, attention-based neural network architecture, etc.). Specific examples of training a transformer-based representation model are shown in FIGS. 5A and 5B. In a second example, the representation model can include a structured state-space architecture (e.g., a state space model including selective state propagation blocks, including Mamba/Mamba2 blocks, structured state-space blocks, etc.). Two specific examples of training a Mamba-based representation model are shown in FIGS. 6A and 6B. In a third example, the representation model can include a hybrid architecture combining attention blocks and state-space blocks (e.g., arranged in parallel and/or arranged in series).

However, the system and/or method can be otherwise performed.

### 2. TECHNICAL ADVANTAGES

Variants of the technology can confer one or more advantages over conventional technologies. Variants of the technology can confer one or more technical advantages over conventional EEG modeling and representation learning systems, particularly in real-world deployments involving long recordings, heterogeneous devices, and variable temporal structure.

First, variants of the technology can enable efficient long-context EEG modeling at practical sampling rates. Conventional transformer-based self-supervised learning (SSL) approaches can perform well for short EEG segments (e.g., less than about 10 seconds), but can incur high memory usage and/or slow inference for long recordings (e.g., greater than about 10 s) due to quadratic scaling with sequence length. Variants can address this bottleneck by leveraging structured state-space models (SSMs) for efficient long-context temporal modeling. In further variants, the system can also include an attention-based representation branch operating alongside the SSM branch to capture complementary cross-channel or content-dependent relationships, while the SSM branch can provide long-sequence efficiency.

Second, variants of the technology can generate device-agnostic brain state representations despite heterogeneous headsets, montages, and/or montage mismatch. EEG recordings can vary across datasets and devices due to differences in channel count, montage configuration, sensor types, sampling rates, sensor placement geometry, and/or other characteristics of the EEG sensor. Even when two headsets nominally share channel labels, their physical sensor coordinates can differ due to cap size, manufacturing tolerances, placement variation, montage definitions, user head shape, and/or other aspects of the sensor. These differences can result in systematic montage mismatch. Conventional approaches (e.g., assuming a fixed montage, a fixed channel ordering, a fixed channel identity set, etc.) can result in learned channel-mixing transformations that are device-specific and thus fail to transfer across devices (e.g., because channels cannot be reliably aligned to the same spatial regions). Variants can address this technical problem by using a coordinate-conditioned input embedding (e.g., a spatial-adaptive input embedding) that conditions input feature construction on sensor position information rather than on channel index alone. This can enable generation of a device-agnostic brain state representation that is compatible with heterogeneous headsets, improves cross-domain transferability, and/or reduces the need for device-specific retraining.

Third, variants of the technology can improve modeling of sub-second temporal semantics or event-locked EEG structure. Conventional EEG methods can rely on empirical fixed-length windowing or patching, which can overlook temporal semantics between windows and can be poorly suited to sub-second segments (unless padding, truncation, resampling, etc. is performed). This fixed-length window can be problematic in time-locked paradigms where components of interest can span sub-second durations. Variants can support variable-length and/or multi-duration processing by tokenizing biosignal data into a plurality of temporal windows having different window lengths (including sub-second windows), optionally using overlapping windows defined by a stride that is less than a corresponding window length, and by determining embeddings for the plurality of temporal windows that are combined to form a unified input representation. In variants, the plurality of temporal windows can include micro-segments (e.g., on the order of about 80-200 ms, such as about 100-120 ms) for capturing microstates and other fast transient dynamics, along with longer windows (e.g., about 1 second, about 2 seconds, about 5 seconds, about 10 seconds, and/or longer) for capturing longer-context trends. Additionally or alternatively, variants can incorporate event timing information to determine time-locked segments (e.g., epochs aligned to event onset) and to generate an event-locked embedding (e.g., an evoked-response embedding) that can be fused with a non-time-locked embedding determined from ongoing biosignal context. This variable-length tolerant solution can improve sensitivity to short-duration components and/or transient dynamics while still supporting longer context windows when needed.

Fourth, variants of the technology can improve robustness of representation learning under low SNR, artifacts, and subject variability. EEG signals can be characterized by low signal-to-noise ratio (SNR) and non-stationarity, which can limit generalization and encourage reliance on handcrafted or subject-specific features. Variants can improve robustness by using self-supervised objectives (e.g., masking-based training, reconstruction-based training, etc.) that encourage stable representation learning despite noise and subject dependence. In further variants, the system can incorporate signal quality indicators and/or artifact-aware processing to reduce sensitivity to poor contact, transient contamination, and/or other practical acquisition issues.

Fifth, variants of the technology can support both single-branch and hybrid modeling in a unified framework. Variants can support multiple execution modes depending on deployment constraints. In a first mode, an SSM-based representation model (e.g., a Mamba-based framework) can be executed (e.g., for long-context modeling). In a second mode, an attention-based representation model (e.g., transformer model) can be executed independently for rich cross-channel relational modeling. In a third mode, the system can execute both branches and fuse their outputs to generate a combined brain state representation, thereby leveraging complementary inductive biases across a wider range of tasks, devices, and sequence lengths.

Sixth, variants of the technology can improve generalization across duration, device, and task using modular self-supervised training mechanisms. In examples, variants can implement a U-shaped SSL framework based on an SSM (e.g., a Mamba-based framework, such as SAMBA) that can integrates: (i) temporally semantic masking to define masked and unmasked EEG segments during training; (ii) spatial-adaptive input embedding conditioned on sensor position information to support heterogeneous montages; and (iii) efficient long-context sequence modeling modules to generate the brain state representation. These mechanisms can reduce reliance on handcrafted features and improve transferability across mixed datasets, segment durations, and device types.

However, further advantages can be provided by the system and method disclosed herein.

### 3. SYSTEM

As shown in FIG. 2, the system can include: a biosignal device 100 and a computing system 200. The system can optionally include: a database, an external device 300 (e.g., a user device), a supplemental sensor, and/or any other suitable components.

The system can include one or more biosignal devices configured to collect biosignal data from one or more users. In a first example, the system can include one or more biosignal devices for a single user. In a second example, the system can include one or more biosignal devices for each user in a set of multiple users (e.g., at least 2 users, at least 5 users, at least 10 users, at least 100 users, at least 1000 users, at least 100000 users, etc.). Examples of form factors of the biosignal device 100 can include: headphones, earbuds, glasses, helmets, caps, a headset, and/or any other suitable form factor.

A biosignal device 100 can include a set of sensors (e.g., electrodes) configured to collect biosignal data from a user. The set of sensors can be configured to detect any one or more of: EEG signals, EOG signals, EMG signals, ECG signals, GSR signals, MEG signals, EcoG signals, iEEG signals, Stentrode signals, any electromagnetic signals, and/or any other suitable biosignals. In an example, the set of sensors can include electrodes (e.g., active electrodes and/or reference electrodes) configured to collect bioelectrical data from a user. In a specific example, the set of sensors (e.g., EEG sensors) can include one or more active electrodes (e.g., channels), one or more reference electrodes, and/or any other type of electrode. The biosignal device 100 can sample biosignal data at a frequency between 0.1 Hz-10000 Hz or any range or value therebetween. However, the biosignal device 100 can include any suitable configuration of sensors.

In variants, operation of the biosignal device 100 can be affected by practical sensing issues, including, but not limited to: missing sensors and/or channels (e.g., absent electrodes, disconnected electrodes, dropped channels, partial channel availability, etc.); noisy contacts (e.g., intermittent contact, motion-induced artifacts, saturation, loose electrodes, cable noise, etc.); electrode impedance variability (e.g., high impedance, drifting impedance, impedance spikes, etc.); asynchronous sampling (e.g., per-channel sampling offsets, clock drift, synchronization errors, etc.); sampling rate variability across devices and/or sessions; missing samples (e.g., packet loss in wireless streaming); and/or coordinate uncertainty (e.g., approximate electrode coordinates, cap placement variability, user-to-user geometry variation, coordinate noise, partial coordinate availability, etc.). In variants, the biosignal device 100 can be configured to detect, quantify, and/or flag one or more of the sensing issues. In examples, the biosignal device 100 can determine and output signal quality metadata for one or more sensors and/or channels, such as: impedance values and/or impedance trends; contact quality indicators; saturation indicators; dropout indicators; noise and/or artifact indicators; per-channel SNR metrics; timestamp accuracy indicators; synchronization indicators; and/or other signal quality metadata. In variants, the biosignal device 100 can package the biosignal data with the signal quality metadata (e.g., per-sample tags, per-window tags, and/or per-channel tags). In further variants, the biosignal device 100 can mitigate sensing variability by applying one or more device-side processes, such as: channel selection; channel re-referencing; common-mode rejection; analog and/or digital filtering; notch filtering; artifact rejection and/or artifact tagging; sample interpolation for missing samples; buffering and timestamping to reduce timing jitter; resampling to a target sampling frequency; and/or other device-side processes. In variants, the biosignal device 100 can output both raw biosignal data and processed biosignal data and/or quality metadata, enabling downstream processing to utilize whichever is available or preferred. In further variants, the biosignal device 100 can store, estimate, and/or output sensor coordinate metadata for the set of sensors, including one or more of: three-dimensional coordinates; two-dimensional projected coordinates; coordinate confidence values; coordinate uncertainty values; and/or mappings to a standard montage. In variants, coordinate metadata can be predetermined (e.g., based on device design, where the predetermined coordinates can be used to initialize a model for further refinement), user-selected (e.g., cap size), estimated during setup, and/or updated over time. In variants, the biosignal device 100 can be configured such that the above sensing issues can be identified and/or mitigated without degrading generation of a brain state representation by downstream processing, because the biosignal data can be accompanied by metadata enabling robust handling of channel availability, timing, sampling, and coordinate uncertainty.

A “montage” can refer to a channel layout used to represent biosignal data, including a set of sensors and/or channels, sensor positions (e.g., sensor coordinates) and/or sensor-to-location mappings, and optionally a referencing scheme (e.g., a reference electrode configuration). In examples, an “input montage” can correspond to a channel layout associated with a biosignal device used to collect biosignal data, and a “target montage” can correspond to a canonical or standardized channel layout (e.g., a standard montage) used to generate a device-agnostic representation. In variants, a set of standard coordinates can include coordinates associated with a target montage (e.g., a set of canonical electrode positions).

The number of sensors in the set of sensors of a biosignal device 100 (e.g., the channel count) can be between 1-100,000 or any range or value therebetween (e.g., 1, 2, 3, 4, 5, 6, 7, 8, 9, 10, 12, 13, 14, 15, greater than 15, at least 100, etc.). In a specific example, the biosignal device 100 can include: 2 channels, 5 channels, 14 channels, 18 channels, 32 channels, 256 channels, and/or any other number of channels (e.g., where a channel corresponds to an active electrode). Each sensor can be positioned at a location on the user (e.g., a location on the head of the user). Each sensor can optionally be associated with a set of sensor coordinates (e.g., 3D coordinates, 2D coordinates, etc.) that corresponds to the sensor location and/or approximates the sensor location. Examples of sensor locations in or on a head of a user (e.g., on the surface of the skin, implanted within the skin, on the surface of the brain, implanted within the brain, etc.) can include: an ear region (e.g., left or right: ear canal region, mastoid, earlobe, etc.), left side of the head, right side of the head, temple, forehead, parietal ridge, temporal lobe region, frontal lobe region, parietal lobe region, occipital lobe region, frontal region (e.g., Fz, Fp1, Fp2, F3, F4, F7, F8, etc.), central region (e.g., Cz, C3, C4, etc.), parietal region (e.g., Pz, P3, P4, P7, P8, etc.), occipital region (e.g., Oz, O1, O2, etc.), temporal region (e.g., T7, T8, etc.), and/or any suitable anatomical location of the user. Sensor coordinates can be: predetermined, manually determined (e.g., input by a user), determined using a look-up table, determined using a model, and/or otherwise determined. In a first example, the biosignal device 100 can include a set of sensors arranged in a standardized format (e.g., 10-05, 10-10, 10-20, etc.), and the coordinates for each sensor in the set of sensors can be assigned using a look-up table (e.g., where each standardized format corresponds to standardized coordinates). In a second example, a user can input the coordinates for each sensor.

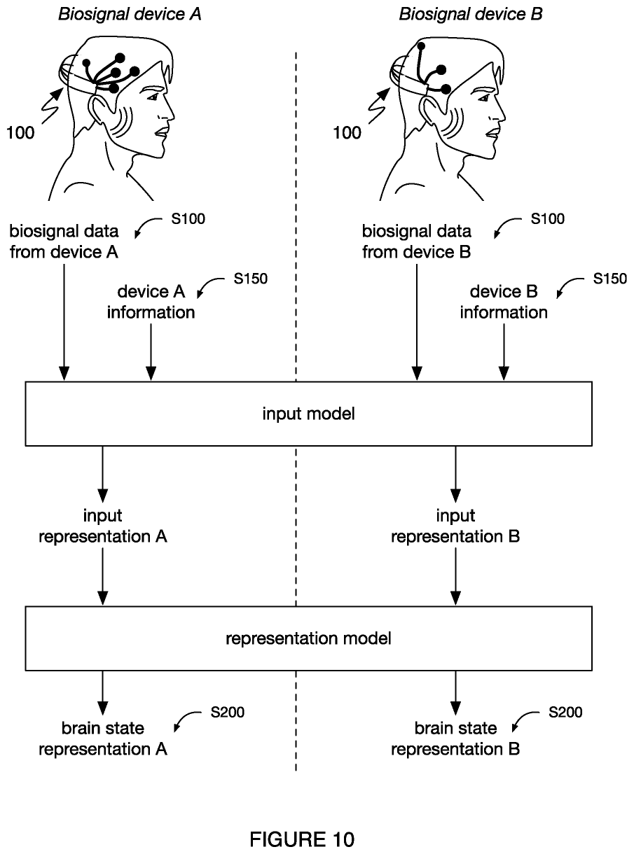

Biosignal devices (e.g., for a single user and/or across different users) can be identical (e.g., the same channel count, the same sensor positioning, the same sensor type, the same form factor, the same measurement frequency, etc.) or different (e.g., different channel counts, different sensor positionings, different sensor types, different form factors, different measurement frequencies, a combination thereof, etc.). An example is shown in FIG. 10. In a first example, a first biosignal device can have a different number of sensors (e.g., EEG sensors) than a second biosignal device. In a specific example, a first biosignal device (e.g., configured to receive biosignals from a first user) has a first number of sensors and a second biosignal device (e.g., configured to receive biosignals from the first user and/or configured to receive biosignals from a second user) has a second number of sensors, greater than the first number of EEG sensors. In an illustrative example, the first biosignal device has less than 10 sensors, and the second biosignal device has greater than 10 sensors. In a second example, a first biosignal device can have a different number of a specific type of sensor (e.g., active electrodes, reference electrodes, etc.). In an illustrative example, the first biosignal device is a 2-channel system (e.g., the first biosignal device includes 2 active electrodes) and a second biosignal device is a 14-channel system (e.g., the second biosignal device includes 14 active electrodes). In another illustrative example, the first biosignal device includes 1 reference electrode and a second biosignal device includes at least 2 reference electrodes. In a third example, a first biosignal device can have a different sensor positioning than a second biosignal device. In a specific example, a first biosignal device has a sensor positioned at a first location on a user (e.g., a first set of coordinates), wherein a second biosignal device does not have a sensor positioned at the first location on a user (e.g., the same user or a different user). In an illustrative example, a first biosignal device has a sensor positioned at an ear region of a user (e.g., an ear canal region), and a second biosignal device does not have a sensor positioned at an ear region of a user. In another illustrative example, a first biosignal device has a sensor positioned behind an ear of a user, and a second biosignal device does not have a sensor positioned behind an ear of a user. In a fourth example, a first biosignal device can sample biosignal data at a different (e.g., greater) measurement frequency than a second biosignal device.

The biosignal device 100 optionally include: an onboard computing system, a communication module (e.g., an electronics subsystem communicatively connecting the sensors to the computing system 200), an input (e.g., keyboard, touchscreen, etc.), an output (e.g., a display), supplemental sensors (e.g., as described below), and/or any other suitable component.

Additionally or alternatively, the biosignal device 100 can include any components described in U.S. patent application Ser. No. 18/625,638 filed 3 Apr. 2024, U.S. application Ser. No. 15/970,583 filed 3 May 2018, U.S. application Ser. No. 18/386,907 filed 3 Nov. 2023, and U.S. patent application Ser. No. 18/375,201 filed 29 Sep. 2023, each of which are herein incorporated in their entirety by this reference.

However, the biosignal device(s) can be otherwise configured.

The system can optionally include one or more supplemental sensors. Specific examples of supplemental sensors can include: motion sensors (e.g., inertial measurement unit, accelerometers, gyrometers, etc.), magnetometers, audio sensors (e.g., microphone), cameras, location sensors, optical sensors (e.g., spectrometer, photodiode, etc.), electrodes (e.g., electrocardiogram electrode), MRI machines, CT machines, impedance sensors, blood pressure sensors, heart rate sensors, oxygen saturation sensors, respiration rate sensors, chemical sensors, and/or any other sensors. However, the supplemental sensor(s) can be otherwise configured.

The system can optionally include one or more external devices. Specific examples of external devices include: smartwatches, smartphones, wearable computing devices (e.g., head-mounted wearable computing device), tablets, desktop computers, medical devices (e.g., glucose sensors, blood alcohol content sensors, etc.), robotic systems (e.g., a robotic prosthetic), user devices, and/or any other suitable device. External device components can include an input (e.g., keyboard, touchscreen, etc.), an output (e.g., a display), an onboard computing system, a communication module (e.g., an electronics subsystem communicatively connecting the external device to the computing system 200), and/or any other suitable component. However, the external device(s) can be otherwise configured.

The system can optionally include or interface with one or more databases (e.g., a system database, a third-party database, etc.). In a first example, the system can include a user database. In specific examples, the user database can store user account information, user profiles, user health records, user demographic information, associated user devices, user preferences, and/or any other user information. In a second example, the system can include an analysis database. In specific examples, the analysis database can store computational models, collected datasets, historical data, public data, simulated data, generated data, generated analyses, diagnostic results, therapy recommendations, and/or any other analysis information. In a third example, the system can include a device database. In specific examples, the device database can store device information for one or more biosignal devices, such as: number of sensors (e.g., channel count), sensor positioning information, sensor type (e.g., for each sensor in the set of sensors), measurement frequency, and/or any other device information. However, the database(s) can be otherwise configured.

The computing system 200 can include one or more: CPUs, GPUs, TPUs, custom FPGA/ASICS, microprocessors, servers, cloud computing, and/or any other suitable components. The computing system 200 can be local (e.g., local to the biosignal device, local to a user device, etc.), remote (e.g., cloud computing server, etc.), distributed, and/or otherwise arranged relative to any other system or module.

Communication between system components can include wireless communication (e.g., WiFi, Bluetooth, radiofrequency, etc.) and/or wired communication. In variations, a biosignal device 100 (e.g., an electronics subsystem of a biosignal device) can be communicatively connected to the computing system 200 (e.g., a processing system) executing a software component.

In variants, the computing system 200 can include a cloud-based service that receives biosignal data (e.g., EEG files, streaming EEG, etc.) via an application programming interface (API) and returns one or more outputs derived from the brain state representation (e.g., biomarker values, feature summaries, alerts, generated content, etc.), while restricting direct access to internal representation layers to reduce reverse engineering risk. In examples, the cloud-based service can support secure fine-tuning and/or adaptation within a controlled environment, where updated parameters can be deployed within the service without exposing internal embeddings to external clients.

The system (e.g., the computing system 200) can implement one or more models. The models can use classical or traditional approaches, machine learning approaches, and/or be otherwise configured. The models can use or include regression (e.g., linear regression, non-linear regression, logistic regression, etc.), decision tree, clustering, association rules, dimensionality reduction (e.g., PCA, t-SNE, LDA, etc.), language processing techniques (e.g., LSA), neural networks (e.g., GNN, CNN, DNN, CAN, LSTM, RNN, FNN, encoders, decoders, deep learning models, transformers, state-space models, joint representation learning models, reservoir models, etc.), ensemble methods, optimization methods (e.g., Bayesian optimization), classification, rules, heuristics, equations (e.g., weighted equations, etc.), selection (e.g., from a library), lookups, regularization methods (e.g., ridge regression), Bayesian methods (e.g., Naïve Bayes, Markov, etc.), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministic models, genetic programs, foundation models (e.g., language models), and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture. The models can extract data features (e.g., feature values, feature vectors, etc.) from the input data, and determine the output based on the extracted features. However, the models can otherwise determine the output based on the input data.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. In a specific example, models can be trained using adversarial training, non-adversarial training (e.g., beneficial training), and/or a combination thereof. The models can be learned or trained on: labeled data (e.g., data labeled with the target label), unlabeled data, positive training sets (e.g., a set of data with true positive labels), negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, the system can be otherwise configured.

### 4. METHOD

As shown in FIG. 1, the method can include: determining biosignal data S100, determining an input representation S200, and determining a brain state representation S300. The method can optionally include determining supplemental information S150, training a representation model S400, determining a biomarker value based on the brain state representation S500, and/or any other suitable steps.

The method can be performed one or more times for each of a set of users, one or more times for each of a set of training datasets, one or more times for each of a set of biomarkers, and/or at any other time. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

All or portions of the method can be performed by one or more components of the system, using a computing system, using a database (e.g., a system database, a third-party database, etc.), user interface, by a user, and/or by any other suitable system.

Specific examples of the system and/or method are described in Appendix A and Appendix B. All or portions of the method can be or include methods as described in U.S. patent application Ser. No. 19/289,470 filed 4 Aug. 2025, which is herein incorporated in its entirety by this reference.

The method can include determining biosignal data S100, which functions to collect measurements of a user's brain. In an example, biosignal data collected for a user can be used to determine a biomarker value for that user. In another example, biosignal data collected for a user (e.g., a training user) can be used to train a model (e.g., an encoder). S100 can be performed one or more times for a user, one or more times for each user in a set of users, and/or otherwise performed. In variants, determining biosignal data S100 can further include preprocessing the biosignal data prior to downstream representation learning and/or biomarker inference. In examples, preprocessing can include one or more of: formatting the biosignal data into a channel-by-time representation; selecting a subset of channels; re-referencing (e.g., common average referencing and/or reference electrode normalization); removing and/or attenuating line noise (e.g., notch filtering); applying band-pass filtering; resampling to a target sampling frequency; synchronizing channels to a common time base; interpolating missing samples; detecting and handling missing channels and/or dropped channels; determining signal quality metadata (e.g., impedance values, contact quality indicators, artifact indicators, saturation indicators, and/or dropout indicators), and/or other suitable preprocessing steps.

Biosignal data can include: electrical data (e.g., bioelectrical data), magnetic data, electromagnetic data, and/or any other type of data. The biosignal data preferably includes measurements of a brain (e.g., neural signals), but can additionally or alternatively include measurements of a heart, skin, and/or any other physiological measurements. Specific examples of biosignal data include: EEG signals, EOG signals, EMG signals, ECG signals, GSR signals, MEG signals, EcoG signals, iEEG signals, Stentrode signals, any electromagnetic signals, motion signals (e.g., from the head and/or other body parts), audio signals, and/or any other suitable biosignals. In an illustrative example, the biosignal data can include measurements of the movement of electrical charges within and/or between neurons within the human brain and/or sensory system. In specific examples, the biosignal data can include measurements of changes in the electric field at one or more sensing positions, such as: the scalp (e.g., EEG measurements of skin surface potentials across the scalp), subcutaneously and/or on the surface of the brain (e.g., EcoG), at locations distributed within the brain (e.g., intracranial—iEEG, vascular—Stentrode, etc.), and/or any other sensing positions. In other specific examples, the biosignal data can include measurements of changes in the magnetic field at one or more sensing positions, generated by the movement of electrical charges (MEG) and/or by a combination of electrical and magnetic measurements.

The biosignal data is preferably measured via the biosignal device 100, but can alternatively be otherwise determined. In a specific example, the biosignal data can include bioelectrical data measured using a set of electrodes (e.g., active electrodes and/or reference electrodes) of a biosignal device 100.

Biosignal data can optionally include unlabeled data and/or labeled data (e.g., where labeled data can be used to train a biomarker model). In a specific example, labeled data can include biosignal data labeled with a biomarker value (e.g., a known neurological state). In an illustrative example, the labeled data can include biosignal data collected during a period of time during which a user (e.g., subject) was experiencing known stimuli (e.g., tasks) and/or was experiencing a known neurological state (e.g., determined by self-report, measured using a supplemental sensor, retrieved from a database, etc.).

However, biosignal data can be otherwise determined.

The method can optionally include determining supplemental information, which functions to collect additional information associated with a device and/or a user. For example, the supplemental information can be used in combination with the biosignal data to: encode the biosignal data into a device-agnostic representation and/or to improve the accuracy of inferring a biomarker value.

Specific examples of supplemental information include: user inputs (e.g., device information input by a user), metadata, device information, data, features extracted thereof, and/or any other supplemental information. Supplemental information can be determined using one or more supplemental sensors, input via a user device (e.g., manual user inputs), retrieved from a database (e.g., from a device database, etc.), determined based on other supplemental information (e.g., features extracted from measurements), manually determined, a combination thereof, and/or otherwise determined. Examples of device information include: number of sensors (e.g., channel count), sensor coordinates (e.g., coordinates for each sensor in the set of sensors), sensor type (e.g., for each sensor in the set of sensors), measurement frequency, contact impedance, and/or any other device information. In a specific example, the supplemental information can include device information for the device used to collect the biosignal data. In a first illustrative example, the supplemental information can include a channel count (e.g., 2 channel, 14 channel, etc.) of the biosignal device 100. In a second illustrative example, the supplemental information can include a sensor position for each sensor of the set of sensors (e.g., channel 1 corresponds to a F7 position, channel 2 corresponds to a T7 position, etc.).

In variants, the supplemental information can include event timing information (e.g., stimulus onset times, cue markers, response markers, trial boundaries, and/or synchronization signals), and the method can include determining one or more time-locked segments of biosignal data (e.g., epochs aligned to event onset). In examples, the representation model can include an event-locked branch that transforms aligned epochs into an evoked-response embedding (e.g., capturing ERP-like features), which can be fused with a non-time-locked embedding generated from ongoing biosignal context. In variants, the event-locked branch can emphasize short-duration components (e.g., sub-second components) and can be trained with a loss that encourages alignment of consistent time-locked patterns across trials and/or across users.

In variants, the method can include using the supplemental information to condition determination of an input representation and/or determination of a brain state representation. In a first example, the method can include determining, using a supplemental encoder, a supplemental embedding based on the supplemental information (e.g., device information, user information, and/or event timing information), and combining the supplemental embedding with an input embedding derived from biosignal data (e.g., by concatenation, element-wise addition, learned weighted summation, cross-attention fusion, and/or any other suitable fusion). In a second example, the method can include concatenating one or more supplemental features (e.g., channel count, sampling frequency, sensor type, impedance metrics, and/or quality indicators) to a biosignal-derived feature vector to form the input representation. In variants, the supplemental information can parameterize one or more transformations applied to the biosignal data and/or the biosignal-derived embedding. In examples, the supplemental information can be used to: select a channel mapping and/or channel projection; select a sampling rate normalization and/or resampling strategy; select and/or configure a masking strategy (e.g., time masking, channel masking, and/or quality-based masking); determine per-channel weights and/or attention biases; determine normalization parameters (e.g., conditioning a normalization layer); and/or determine one or more gating values that modulate contributions of different feature streams (e.g., gating between spatial-adaptive features and temporal features). In a specific example, impedance values and/or contact quality indicators can be used to down-weight, mask, and/or ignore channels and/or time windows that satisfy a low-quality criterion, while preserving higher-quality portions of the biosignal data. In variants, the supplemental information can be used to condition an event-locked branch and/or an ongoing-context branch. In examples, event timing information can be used to define epochs aligned to events, and an event-locked embedding determined from aligned epochs can be fused with a non-time-locked embedding determined from ongoing biosignal context (e.g., by concatenation and projection to a joint embedding space, and/or by attention-based fusion), wherein the supplemental information optionally controls the fusion (e.g., via a gate determined from task type, event type, and/or segment duration). In variants, the supplemental information can be used during training to determine learning targets, losses, and/or sampling policies. In examples, the supplemental information can be used to: select a loss function (e.g., reconstruction loss vs latent loss); weight losses based on signal quality; balance sampling across device types and/or segment durations; and/or select masking ratios based on segment duration, channel count, and/or measured quality.

However, supplemental information can be otherwise determined.

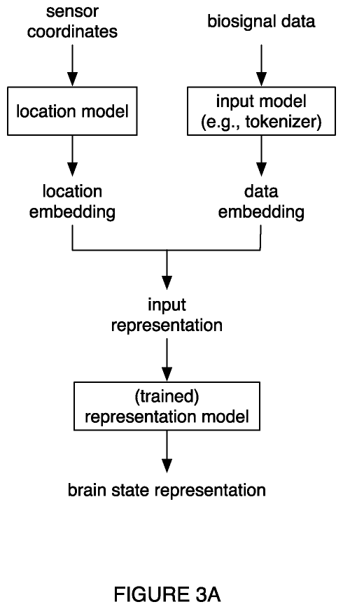

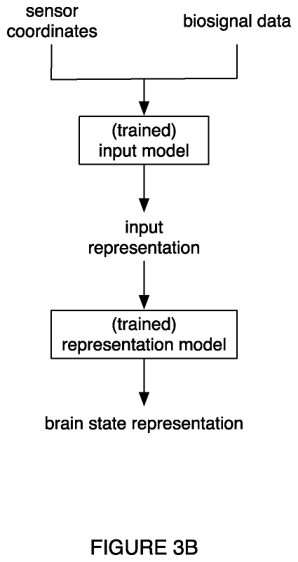

Determining an input representation S200 functions to: standardize the representation of the neurological state across devices (e.g., across different channel counts, across different sensor positions, etc.), reduce artifacts, handle varying biosignal data recording lengths, extract relevant features (spatial and/or temporal features) from the biosignal data and/or supplemental information (e.g., sensor coordinates), and/or otherwise transform the biosignal data and/or supplemental information. Examples are shown in FIG. 3A and FIG. 3B.

The input representation can be or include: feature values, a signal, an embedding (e.g., an embedding within a learned latent space), a combination thereof, and/or any other representation of the biosignal data and/or supplemental information. The input representation (e.g., an input embedding) can optionally be determined using one or more input models (e.g., arranged in parallel and/or in series). In variants, determining the input representation S200 can include executing a an input model (e.g. a trained input model). Inputs to the input model can include: biosignal data (e.g., processed and/or unprocessed biosignal data), supplemental information (e.g., sensor coordinates, device metadata, signal-quality metadata, standard coordinates associated with a target montage, etc.), one or more input representations (e.g., determined using another input model), and/or any other suitable information. In examples, sensor coordinates can include coordinates for each biosignal sensor (e.g., 2D scalp coordinates and/or 3D coordinates). Outputs from the input model can include an input representation (e.g., input embedding). For example, sensor coordinates and the biosignal data can be transformed (e.g., separately encoded, jointly encoded, etc.) into the input representation. In a specific example, an input model (e.g., a trained input model) can be configured to transform biosignal data and/or sensor position information (e.g., sensor coordinates and/or sensor-coordinate-derived features) into an input representation (e.g., an input embedding) usable by a downstream representation model for determining a brain state representation. In variants, an input model can optionally include one or more input models. In a specific example, outputs of the input model can include an input representation (e.g., an input embedding) that encodes spatial and/or temporal features of the biosignal data in a manner that supports device-agnostic processing.

In a first variant, the input model can include a first input model (e.g., a location model) configured to generate a location embedding from sensor coordinates and a second input model (e.g., a data model) configured to generate a data embedding from biosignal data, wherein the input representation is determined based on both the location embedding and the data embedding (e.g., by concatenation and projection, learned weighted summation, gating, and/or other fusion). In a second variant, the input model can jointly encode biosignal-derived features with sensor-coordinate-derived features such that the input representation is determined based jointly on the biosignal data and the sensor position information (e.g., where sensor position information conditions feature construction rather than being appended only at a final layer).

In variants, determining the input representation can include combining outputs of a plurality of input models arranged in parallel and/or in series. In a parallel arrangement, each input model can process a common input (e.g., the biosignal data and/or a coordinate-conditioned embedding) to generate a respective embedding, and the computing system can combine the respective embeddings to determine the input representation (e.g., concatenation followed by projection, learned weighted summation, gating, and/or cross-attention fusion). In a series arrangement, an output embedding of a first input model can be provided as an input to a second input model to determine a refined embedding, wherein the refined embedding defines the input representation.

In variants, the one or more input models described herein can be implemented as one or more input models configured to determine the input embedding (e.g., the input representation) from biosignal data and sensor position information.

In a first variant, the input representation can include frequency features. In examples, the input representation can include coherence, phase, and/or any other spectral features. In a specific example, the input representation can be determined using a Fast Fourier Transform.

In a second variant, the input representation can include an embedding determined using a neural network (e.g., a CNN).

In a third variant, the input representation can include a sequence of tokens (e.g., determined using a tokenizer).

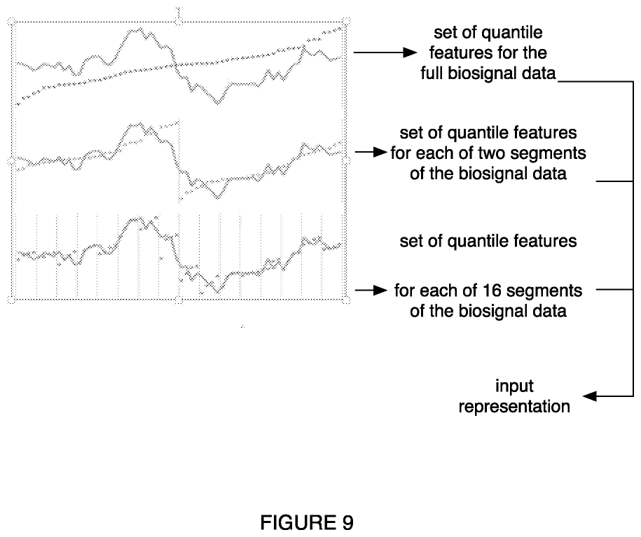

In a fourth variant, the input representation can include quantile features (e.g., the input representation can include a quant embedding). An example is shown in FIG. 9. For example, each channel of the biosignal data can be segmented (e.g., in 2, 3, 4, 5, 6, 7, 8, 12, 14, 16, 32, more than 32, etc.), and a set of quantile features can be extracted from each segment. In a specific example, the set of quantile features can include a quantile for one or more of: time domain, frequency domain, first derivative, and/or second derivative. The set of quantile features can be determined for different segment lengths (e.g., subsequence length). In a specific example, this can enable the input representation to include information at different granularities. In an illustrative example, the set of quantile features can be determined for each segment in a set of segments, where the set of segments can include: the full biosignal data, ½ of the biosignal data, ¼ of the biosignal data, ⅛ of the biosignal data, 1/16 of the biosignal data, a combination thereof, and/or any other segmentation level. The set of segments can optionally be overlapping (e.g., the biosignal data can be segmented using a shifted interval). In variants, using quantile features can improve robustness of the input representation because quantiles can summarize a distribution of signal values in a manner that is less sensitive to outliers and/or less sensitive to absolute amplitude scaling (e.g., when compared with raw sample values). For example, quantile features can reduce sensitivity to transient spikes, saturation events, and/or motion artifacts that can disproportionately affect mean-based or squared-error-based features. In variants, quantile features can provide a scale-stable embedding across heterogeneous devices and sessions. In examples, differences in sensor gain, contact impedance, referencing, and/or device-specific scaling can change absolute amplitudes while preserving relative structure of signal distributions; quantile features can preserve distributional structure while reducing dependence on absolute scale, thereby improving cross-device generalization. In variants, quantile features can support multi-granularity characterization of non-stationary biosignals. For example, quantile features computed on shorter segments can capture transient dynamics, while quantile features computed on longer segments can capture baseline shifts and longer-timescale trends. In variants, combining quantile features across segment lengths can provide a compact representation that encodes both short- and long-timescale properties of the biosignal data. In variants, quantile features can be combined with other input representations (e.g., token embeddings and/or spatial-adaptive embeddings) by concatenation and projection to a shared embedding space, enabling quantile-derived statistics to complement waveform-derived and/or spatially-conditioned features.

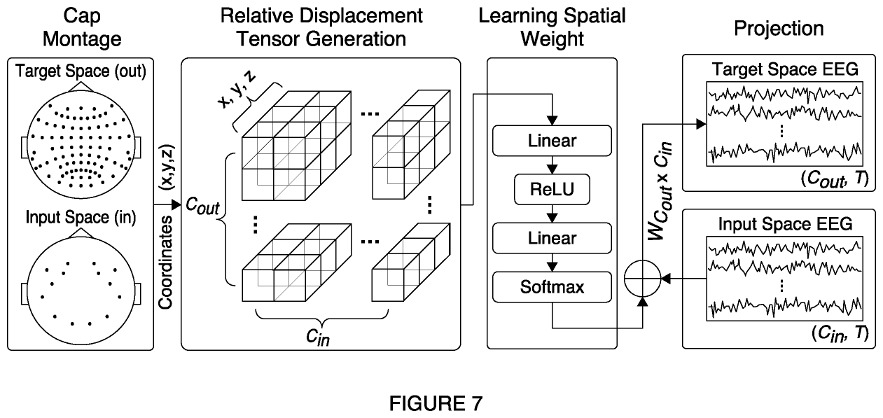

In a fifth variant, the input representation can include a location embedding. In an example, the location embedding can be determined using a location model (e.g., an input model). Inputs to the location model can include device information (e.g., sensor coordinates), and outputs from the location model can include the location embedding. The location model can use classical or traditional approaches (e.g., not a trained model), and/or can be a trained model. In a first example, the location model can use sine and/or cosine functions to encode the sensor coordinates for each sensor (e.g., as described in Appendix A). In a second example, the location model can determine the location embedding based on the sensor coordinates and a standard set of coordinates (e.g., where the standard set of coordinates represent a standard biosignal device montage). In a specific example, the input representation can be a spatial-adaptive input embedding (e.g., as described in Appendix B) that projects biosignal data to a target space based on the sensor coordinates (e.g., using spatial weights derived from the delta between the sensor coordinates and the standard coordinates); an example is shown in FIG. 7. In a specific example, the location model can be trained with the representation model (e.g., using end-to-end training). In variants, the spatial-adaptive input embedding can function as a montage projection layer that maps heterogeneous headset layouts into a universal coordinate system (e.g., a canonical scalp coordinate system and/or a standard montage). In variants, the montage projection can be robust to missing channels, dropped channels, and/or partial coordinate availability. In examples, if one or more sensors are missing or low quality, the system can down-weight or omit the corresponding sensors when determining weights, and renormalize remaining weights. In variants, the system can account for coordinate uncertainty (e.g., noisy coordinates, approximate coordinates, and/or cap placement variability) by smoothing the weighting function, using multiple neighbor sensors per standard coordinate, and/or training with coordinate perturbations. In examples, the mapping can be parameterized by spatial weights derived from relative electrode coordinates (e.g., differences between an input electrode position and one or more target montage positions), and can optionally include a learned spatial weighting mechanism that assigns higher weight to spatially proximate electrodes. In variants, electrode mapping can enable and/or improve device-agnostic processing across different channel counts and electrode layouts (including unseen layouts), thereby enabling cross-device compatibility without requiring channel-name matching. In examples, the learned spatial weighting mechanism can be implemented using an attention mechanism, a gating function, a kernel-based weighting function, a learned distance-to-weight model, a graph-based message passing model, and/or any other learned weighting model.

In a sixth variant, the input representation can include a temporal-receptive embedding (e.g., as described in Appendix B). For example, the input representation can extract short-, mid-, and/or long-range temporal features (e.g., at multiple resolutions) from the biosignal data and/or another input embedding (e.g., from a spatial-adaptive input embedding). In a specific example, the input representation can be determined using one or more convolutions.

In a seventh variant, the input representation can include a spatio-temporal input embedding including a spatial-adaptive input embedding and a temporal-receptive embedding. In examples, the spatial-adaptive input embedding can be determined by projecting biosignal data from an input montage to a target montage as described above, thereby producing a device-agnostic channel layout. The temporal-receptive embedding can then be determined based on the spatial-adaptive input embedding to capture temporal structure at one or more time scales. In variants, determining the temporal-receptive embedding can include applying one or more temporal convolutions to the spatial-adaptive input embedding, wherein the temporal convolutions are configured to extract features at multiple temporal resolutions. In examples, the computing system can apply a set of temporal convolutional kernels having different kernel sizes and/or dilations to capture both short-duration and longer-duration temporal patterns. In a first example, parallel temporal convolutions can be applied to the same input sequence to generate multiple feature streams (e.g., a short-receptive stream and a long-receptive stream), and the feature streams can be combined (e.g., concatenation followed by projection, learned weighted summation, and/or gating) to determine the temporal-receptive embedding. In a second example, temporal downsampling (e.g., pooling) and temporal upsampling (e.g., interpolation) can be used to form multi-resolution features and combine them into a single temporal-receptive embedding. In variants, temporal-receptive embedding generation can be applied to windows of different durations (e.g., sub-second windows, one-second windows, multi-second windows). In examples, windows can be overlapping, wherein overlap is defined by a stride that is less than a window length. In variants, embeddings determined for different window durations can be combined to form the input representation (e.g., by fusion into a shared embedding space). In examples, the input representation (including the spatio-temporal input embedding) can be provided to a representation model (e.g., a trained representation model) configured to determine a brain state representation. In examples, the representation model can include an attention-based model, a structured state-space model, and/or a hybrid model, and can consume the spatio-temporal input embedding as a device-agnostic representation of the biosignal data.

In an eighth variant, the input representation can include a combination of two or more of the previous variants. In a first example, a location embedding can be combined (e.g., concatenated) with a set of quantile features. In a second example, the input representation can include a spatio-temporal and/or spatial-adaptive input embedding (e.g., as described in Appendix B) that includes a combination of a spatial-adaptive input embedding and a temporal-receptive embedding, where the temporal-receptive embedding is determined based on the spatial-adaptive input embedding. An example is shown in FIG. 6. In a third example, the input representation can be a projection of another input representation. For example, a model (e.g., a transformer) can project an input representation (e.g., the set of quantile features, the location embedding, etc.) to an embedding dimension (e.g., 128 dimensions, 256 dimensions, etc.).

In a ninth variant, the input representation can include multi-duration tokenization to support biosignal segments spanning a wide duration range (e.g., about 120 milli-seconds to about 10 seconds or greater). In a first example, biosignal data can be tokenized into overlapping windows having a medium window length (e.g., about 1 second). In examples, “overlapping” can mean that adjacent windows have a stride less than a window length (e.g., about 10% overlap, about 25% overlap, about 50% overlap, etc.). In a specific example, for a 1-second window, the stride can be about 0.5 seconds (50% overlap), and for micro-segments (e.g., about 100-120 ms), the stride can be about 10-60 ms. In a second example, the biosignal data can be tokenized into windows having longer window lengths (e.g., about 2 seconds, about 5 seconds, about 10 seconds, etc.). In a third example, the biosignal data can be tokenized into micro-segments (e.g., about 80-200 ms, about 100-120 ms, etc.) to capture microstates and/or fast transient dynamics. In variants, multiple token streams (e.g., micro, short, medium, long) can be processed in parallel and fused into a unified input embedding. In these examples, “micro,” “short,” “medium,” and “long” tokenization windows can correspond to different window-length ranges. For example: micro can be about 80-200 ms; short can be about 200-800 ms; medium can be about 0.8-2 seconds (e.g., about 1 second); and long can be about 2-10 seconds or greater (e.g., about 5 seconds, about 10 seconds, etc.). However, any suitable window-length ranges can be used.

However, the input representation can be otherwise determined.

Determining a brain state representation S300 functions to transform the biosignal data into an embedding. This transformation can function to: reduce dimensions (e.g., which can increase computational efficiency), surface relevant features of the biosignal data (e.g., relevant to the neurological state as a whole, relevant to a specific biomarker of interest, etc.), and/or standardize the representation of the neurological state across users and/or across devices (e.g., across different channel counts, across different sensor positions, etc.). The brain state representation is preferably an embedding within a latent space (e.g., a learned latent space), but can additionally or alternatively be any other representation of the biosignal data. In a specific example, the brain state representation can be a vector (e.g., a vectorized representation). In an example, the brain state representation can transform the neurological state of a user to a standardized human brain (e.g., the learned latent space of the representation model).

The brain state representation can be determined based on the biosignal data, one or more input representations, supplemental information (e.g., device information), and/or any other suitable information. The brain state representation can optionally be determined using a representation model. Inputs to the representation model can include: biosignal data, the input representation (e.g., input embedding), supplemental information, and/or any other suitable inputs. Outputs from the representation model can include all or a portion of a brain state representation for a user.

In examples, the representation model can be or include: a foundation model, encoder, a mediator, a decoder (i.e., autoregressive model), an autoencoder (i.e., encoder plus decoder), an ensemble of encoders (e.g., joint embedding predictive architecture (JEPA)), generative model (e.g., GAN, diffusion, etc.), linear model, attention layer, convolution, Max Pool, upsampling, downsampling, and/or any other suitable model. In specific examples, blocks inside the representation model (e.g., inside an encoder and/or decoder) can include: an attention model (also referred to as an attention-based model such as a transformer, RNN, CNN, LSTM, etc.), a state-space model (e.g., Mamba, S4/Mamba, Mamba2, etc.), and/or any other suitable blocks. In this disclosure, a “block” can refer to a computational module (e.g., one or more layers and associated operations) configured to receive an input tensor and output an output tensor, optionally including normalization, nonlinear activation, residual connections, and/or gating.

In a first variant, the representation model can include a transformer block (e.g., as described in Appendix A). For example, the representation model can include an 8-layer transformer. In a specific example, the representation model can use models as described in: Navid Mohammadi Foumani, Geoffrey Mackellar, Soheila Ghane, Saad Irtza, Nam Nguyen, and Mahsa Salehi. 2024. EEG2Rep: Enhancing Self-supervised EEG Representation Through Informative Masked Inputs. In Proceedings of the 30th ACM SIGKDD Conference on Knowledge Discovery and Data Mining (KDD '24). Association for Computing Machinery, New York, NY, USA, 5544-5555. https://doi.org/10.1145/3637528.3671600, which is incorporated in its entirety by this reference.

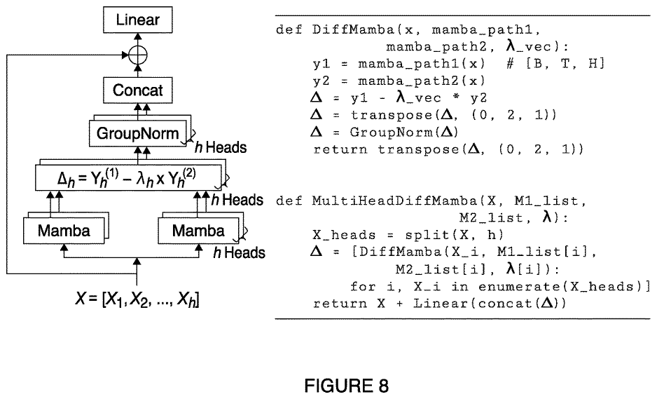

In a second variant, the representation model can include a Mamba block (e.g., as described in Appendix B). Examples are shown in FIG. 6 and FIG. 8. For example, the representation model can include a multi-head differential Mamba block. In variants, the multi-head differential Mamba block can suppress redundancy and emphasize salient temporal structures. The Mamba block can optionally be combined with one or more attention layers. In an example, the representation model can use a learning framework that includes a Mamba-based U-shaped encoder-decoder architecture (e.g., encoder-mediator-decoder architecture). In variants, this architecture can capture long-range temporal dependencies and spatial variability in the biosignal data. In an example, the encoder can include one or more stages (e.g., 3 stages) of increasing depth and decreasing temporal resolution. In a specific example, the first stage can apply a linear projection followed by a Mamba2 block to capture fine-grained temporal dynamics. In a specific example, the second and third stages can use 1D convolutions and/or max pooling to downsample the temporal dimension while expanding the feature dimension (e.g., enabling subsequent Mamba blocks to model longer-range dependencies over compact feature representations). In variants, this hierarchical design can support sequences of varying length without requiring fixed-size temporal windows or architectural modifications. In an example, the mediator includes a multi-head differential mamba module, which can contrast parallel state-space dynamics across multiple heads and suppress noise. In an example, the decoder (e.g., used during representation model training) can mirror the encoder with symmetric structure and can optionally perform upsampling via parameter-free linear interpolation (e.g., instead of transposed convolutions). In variants, this can avoid checkerboard artifacts and/or can better preserve the continuity of EEG signals. Each upsampled feature map can optionally be refined by a Mamba2 block to restore long-range temporal patterns. In variants, the representation model (e.g., the encoder, encoder-mediator-decoder, etc.) can include a multi-scale receptive-field module that can apply parallel temporal convolutions with different kernel sizes (e.g., 1, 3, 7, etc.) to capture short-, mid- and/or long-range structure prior to state-space processing. In variants, an encoder stage can include a channel-mixing projection (e.g., linear projection across channels) followed by a state-space block (e.g., Mamba2) to capture fine-grained temporal dynamics, subsequent stages can include temporal downsampling (e.g., max pooling) and temporal convolutions to expand feature dimension while reducing temporal resolution, and a decoder can upsample (e.g., interpolation-based upsampling) and optionally apply additional state-space blocks to restore long-range temporal patterns while leveraging skip connections.

The brain state representation can optionally be determined using the representation model and a supplementary model. In variants, the supplementary model can be used to fine-tune the input and/or output of the representation model for a specific application (e.g., for a specific use case). Examples of applications include: a biomarker, an experiment type, a user demographic, a biosignal device configuration, a specific user, a specific biosignal device, and/or any other application. In an example, the supplementary model can output a supplementary representation based on an application of interest. In a first specific example, the supplementary representation can be aggregated with the input representation (e.g., concatenated together), wherein the aggregate representation can be used as the input representation in all or portions of the method (e.g., as an input to the representation model). In a second specific example, the supplementary representation can be aggregated with the brain state representation (e.g., concatenated together), wherein the aggregate representation can be used as the brain state representation in all or portions of the method (e.g., as an input to the biomarker model). However, the supplementary model can be otherwise used.

In a third variant, the representation model can include a hybrid variant, where the hybrid variant can be in a parallel architecture that processes a common input embedding using an attention-model branch (e.g., attention model mode) and a state-space-model branch (e.g., state-space-model mode), and determines a brain state representation (e.g., from the combined outputs, by selecting from the outputs of the different branches, etc.). In a first example, the attention-model branch can include one or more attention blocks configured to capture flexible, content-addressable relationships (e.g., cross-channel and cross-time relationships), and the state-space-model branch can include one or more structured state-space blocks configured to capture long-range temporal dependencies with improved efficiency. Outputs of the branches can be combined by concatenation, learned weighted summation, cross-attention fusion, via a gating network that selects or weights branch contributions in a mixture-of-experts manner, and/or in any other suitable manner (e.g., using voting). In variants, the gating network can be conditioned on one or more of: device information, SNR metrics, detected artifact level, sequence length, task or application identifier, and/or stimulus timing information when available. In a second example, the brain state representation can include a multi-part representation including: a state-space-derived long-context embedding and an attention-derived relational embedding, wherein downstream biomarker models can consume one or both parts. In variants, this design can improve robustness and generalization by leveraging complementary inductive biases of attention models and state-space models. In some variations of this variant, a single mode can be selected (but where either mode can be used) for determination of the brain state representation (e.g., where the mode can be selected based on the biosensor, application, user preference, etc.).

In a fourth variant, the hybrid architecture (e.g., from the third variant) can be arranged in series. In a first example, the attention-model branch can output an intermediate representation that is then processed by a state-space-model branch to capture long-context dependencies. In a second example, the state-space-model branch can output an intermediate representation that is then processed by an attention-model branch to capture relational structure (e.g., cross-channel interactions). In variants, serial ordering can be selected based on compute constraints and/or target tasks, and can optionally require fine-tuning of positional encoding and/or channel embedding strategies to maintain compatibility across branch types.

The brain state representation can optionally be determined and/or processed using methods as described in U.S. patent application Ser. No. 19/289,470 filed 4 Aug. 2025, which is herein incorporated in its entirety by this reference.

However, the brain state representation can be otherwise determined.

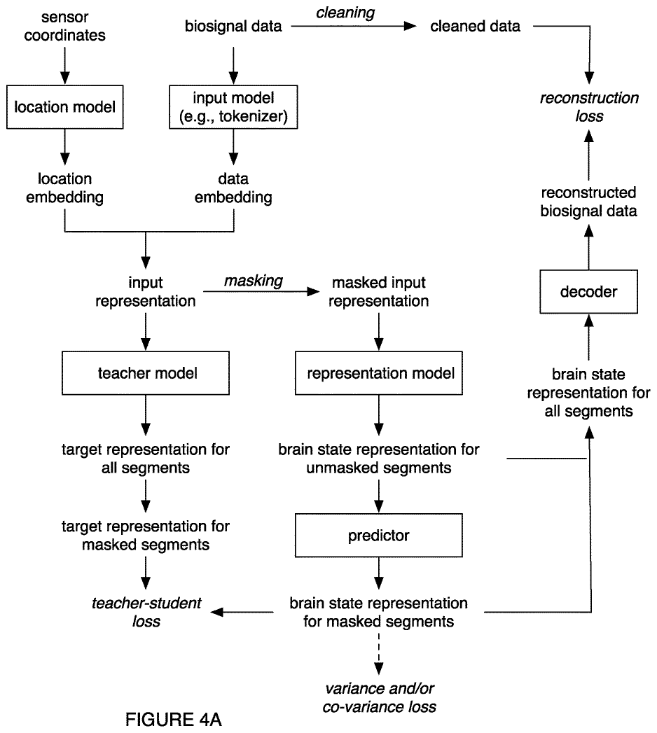

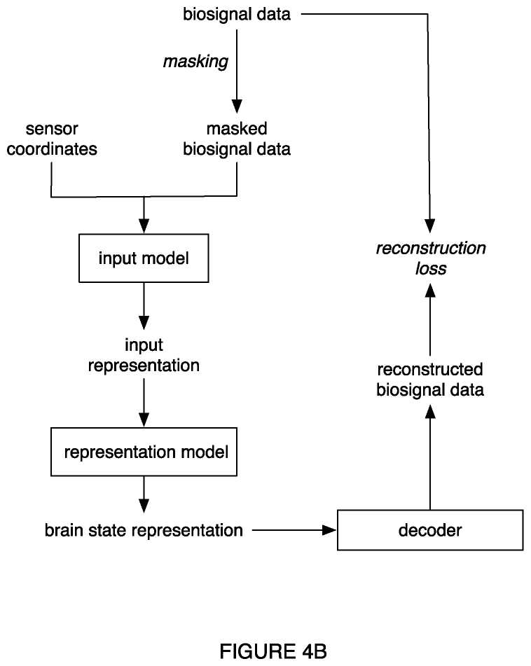

The method can optionally include training a representation model S400, which functions to learn the latent space for the latent space for the brain state representation. S400 can optionally include training one or more input models and/or any other models (e.g., via end-to-end training). Examples are shown in FIG. 4A, FIG. 4B, FIG. 5, and FIG. 6.

Training the representation model can optionally include masking strategies. Examples of masking strategies include: temporal semantic random (TSR) masking (e.g., as described in Appendix B), semantic subsequence preserving (SSP) masking, random masking, masking a latter segment (e.g., for prediction of a future brain state representation), and/or any other masking strategy. The masking ratio can optionally increase during training (e.g., when implementing curricular learning). In a first example, training the representation model can include masking the input representation, determining a brain state representation for the unmasked segments of the input representation, and determining a loss based on the brain state representation for the unmasked segments (e.g., directly from the brain state representation for the unmasked segments, based on a reconstructed signal decoded from the brain state representation, based on a predicted brain state representation for the masked segments, etc.). An example is shown in FIG. 4A. In a second example, training the representation model can include masking the biosignal data, determining the input representation based on the unmasked segments of the biosignal data, determining a brain state representation for the unmasked segments based on the input representation, and determining a loss based on the brain state representation for the unmasked segments (e.g., directly from the brain state representation for the unmasked segments, based on a reconstructed signal decoded from the brain state representation, based on a predicted brain state representation for the masked segments, etc.). An example is shown in FIG. 4B. In variants, a predictor can be used to output a brain state representation corresponding to masked segments (masked segments of the input representation and/or of the biosignal data), and a loss can be determined based on the predictor output (e.g., the brain state representation for the masked segments). In an example, the loss can be determined based on the brain state representation for the masked segments and the brain state representation for the unmasked segments (e.g., the full brain state representation).

In variants, determining the input representation can include projecting biosignal data from an input montage to a target montage using spatial weights derived from differences between sensor coordinates and standard coordinates. In a first example, for each target position (associated with a standard coordinate), the system can determine a set of weights over input sensors based on relative coordinate differences between the standard coordinate and each sensor coordinate of the input montage. The weights can be applied to biosignal data measured at the input sensors to determine a target-montage channel value (e.g., a weighted combination of input channels) for the target position. Repeating this procedure across the set of standard coordinates can produce a target-montage signal representation having a consistent channel layout across heterogeneous devices.

In variants, the spatial weights can be determined as a function of a coordinate difference (e.g., a delta) between a sensor coordinate and a standard coordinate. In examples, the spatial weights can be determined using a distance-based function (e.g., inverse distance weighting, a Gaussian kernel over distance, radial basis weighting, and/or normalized kernel weighting), and can be normalized (e.g., such that weights sum to one for a given standard coordinate). In a specific example, for a given standard coordinate s; and an input sensor coordinate pᵢ, a weight w_{j,i} can be determined from a function of |pᵢ−pⱼ|, and a target-montage channel value for standard coordinate sⱼ can be determined as a weighted combination Σᵢ w_{j,i}xᵢ(t), where xᵢ(t) is the biosignal time series from input sensor i. In further variants, the spatial weights can be learned. In examples, a learned weighting model can receive coordinate differences (and optionally device metadata) and output weights used to project biosignal data to the target montage. The learned weighting model can be implemented using a learned kernel model, a gating model, an attention mechanism, a graph-based message passing model, and/or any other learned weighting mechanism. In variants, the learned spatial weighting mechanism can be trained end-to-end as part of determining the input representation. However, weights can be otherwise determined.

In a first variant, the representation model can be trained using a teacher-student loss (e.g., an L₂ loss as described in Appendix A). For example, an unmasked input representation can be passed as an input to a teacher model (e.g., target model) to output a target representation, and a masked input representation can be passed as an input to the representation model to output a brain state representation for the unmasked segments, and the teacher-student loss can be determined based on the target representation and the brain state representation for the unmasked segments. In a specific example, the teacher-student loss can be calculated by comparing: (a) the segments of the target representation corresponding to the masked segments of the input representation to (b) the brain state representation for the masked segments, predicted from the brain state representation for the unmasked segments.

In a second variant, the representation model can be trained using a reconstruction loss (e.g., an L_{Rec} loss as described in Appendix A, a Time-Frequency loss as described in Appendix B, etc.). For example, a reconstructed biosignal data can be generated by decoding (via a decoder) the brain state representation (e.g., decoding the combination of the brain state representation for the masked segments and the brain state representation for the unmasked segments) In a first example, the reconstruction loss can be determined by comparing the reconstructed biosignal data to the original biosignal data. In a second example, the reconstruction loss can be determined by comparing the reconstructed biosignal data to cleaned biosignal data. In a specific example, the cleaned biosignal data can be determined using filtering methods, independent component analysis (ICA), Riemannian artifact subspace reconstruction (rASR), and/or any other artifact removal processes. In a specific example, cleaning the biosignal data can include removing artifacts (e.g., noise, artifacts due to heart rate, artifacts due to muscle signals etc.). In a first embodiment, the reconstruction loss can be determined using mean squared error (MSE) loss function. In a second embodiment, the reconstruction loss can be determined using a hydra loss function or a hydra-family loss function. In an example, the hydra loss function can map the reconstructed biosignal data to a new space (e.g., a component-decomposed latent space) by applying kernels (e.g., random kernels) to both the original biosignal data (e.g., cleaned or raw biosignal data) and the reconstructed biosignal data, and can compare the two signals in the new space. In variants, the hydra loss function can provide meaningful alignment, stabilize training, improve generalization across application, capture high frequency and low frequency behavior, and/or provide other benefits. In variants, the hydra-family loss can map a reconstructed biosignal and a target biosignal into a component-decomposed latent space by applying a plurality of kernels (e.g., random kernels and/or learned kernels) at multiple dilations and/or receptive-field sizes to generate a set of component channels (e.g., low-frequency components, mid-frequency components, high-frequency components, and/or shape components). The loss can then compare the component channels (e.g., via an MSE or L1 metric per component) and aggregate the component losses (e.g., weighted aggregation). In variants, the hydra-family loss can balance comparisons across frequency bands, preserve high-frequency details that would otherwise be diluted under raw MSE, stabilize training under low-SNR conditions, and/or improve generalization across devices and applications. In a third embodiment, the reconstruction loss can be determined using a time-frequency loss function (e.g., as described in Appendix B). For example, the time-frequency loss function can combine a mean absolute error loss (e.g., L1 loss) computed in the time domain with a spectral alignment loss computed in the frequency domain (e.g., based on the discrete Fourier transform). In a specific example, the time-frequency loss function can preserve both time-domain waveform and frequency-domain structure. In variants, this joint objective can encourage the representation model to maintain fidelity in both temporal shape and frequency content, supporting robust biosignal data modeling. In variants, the time-frequency loss can compare the full frequency spectrum (e.g., via a real-valued Fourier transform) rather than only pre-defined band powers, thereby preserving global oscillatory structure while maintaining waveform fidelity. In further variants, a time-frequency loss can additionally or alternatively use a wavelet-domain comparison (e.g., multi-resolution time-frequency coefficients) to emphasize short-window high-frequency structure and long-window low-frequency structure in a unified objective. In a further embodiment, the reconstruction loss can be determined in a dictionary-transformed space rather than directly in raw signal space. In examples, a dictionary-inspired convolutional transformation layer (e.g., a “DiCT” layer, a “dictionary-based convolution transform,” and/or a “dictionary-based convolution transformer (DEIC)” layer) can project a reconstructed biosignal, a target biosignal (e.g., cleaned biosignal data and/or raw biosignal data) into a structured feature space prior to computing a loss metric (e.g., MSE, L1, Huber, and/or a weighted MSE). In a specific example, the dictionary transform can apply a set of convolutional kernels having multiple dilations and/or receptive-field sizes to preserve low-, mid-, and high-frequency components, and can optionally include competing kernels within groups (e.g., selecting or weighting kernels per group) to emphasize shape-aware similarities. In variants, determining the loss in the dictionary-transformed space can reduce sensitivity to amplitude-dominated artifacts, preserve high-frequency details that are underweighted by raw MSE, and improve cross-device generalization by aligning salient time-frequency structure rather than raw sample-by-sample differences.

In variants, the cleaned biosignal data can be determined via an artifact removal pipeline that outputs a cleaned target signal while preserving neural content. In examples, the artifact removal pipeline can include: band-pass filtering, line-noise removal, decomposition of the biosignal into components (e.g., independent components), classifying components as brain vs artifact (e.g., ocular, muscle, cardiac, motion, line noise), removing artifact components, and reconstructing a cleaned signal from the remaining components. In variants, the artifact removal pipeline can be applied only for training target generation, such that the representation model learns to predict (or reconstruct) the cleaned target signal from a noisy input signal, thereby discouraging representations that encode non-brain artifacts. In further variants, the artifact removal pipeline can include rASR, wavelet denoising, regression-based denoising, spatial filtering, and/or any other artifact removal processes.

In a third variant, the representation model can be trained using a covariance loss and/or variance loss. For example, the output of the predictor can include multiple brain state representation segments (e.g., the brain state representation corresponding to each masked segment), and the loss can be or be determined based on the covariance and/or the variance between multiple brain state representation segments. In variants, this can push the representation model to decorrelate portions of the brain state representation.

In variants, the loss can be determined in latent space, in raw space, and/or as a weighted combination thereof. In a first example, the representation model can output a latent representation for an unmasked input and a latent representation for a masked input (e.g., via a teacher-student loss), and a latent loss can be determined by comparing latent representations corresponding to masked segments. In a second example, the representation model can include a decoder that reconstructs a biosignal in raw space, and a raw loss can be determined by comparing a reconstructed biosignal to a target biosignal. In a third example, the raw loss can be determined after mapping both signals through a dictionary transform (e.g., DiCT/DEIC) as described above, thereby effectively performing a latent-space comparison of reconstructed-vs-target signals prior to applying a squared-error metric.

In variants, training can include mixed-dataset training across heterogeneous biosignal devices (e.g., different headset types, channel counts, electrode layouts, sampling rates, and recording lengths). In examples, a training batch can include samples from multiple devices and multiple segment durations, and the training procedure can include balancing strategies (e.g., per-device sampling weights, per-duration sampling weights, and/or curriculum learning) to avoid overfitting to a dominant device or dominant segment length. In a specific example, a curriculum can begin with shorter segments (e.g., about 120 milliseconds, about 1 second, about 2 seconds) and progressively include longer segments (e.g., about 5 seconds, about 10 seconds, and/or longer) while maintaining a consistent masking ratio and/or a consistent number of visible time steps.

Training the representation model can optionally include fine-tuning for a specific application. In a first variant, the entire representation model can be fine-tuned. In a second variant, fine-tuning the representation model can include parameter efficient fine tuning (PEFT). For example, fine-tuning the representation model can include LoRA fine-tuning. In a specific example, different rank decomposition matrices can be trained for different applications (e.g., tasks). In a third variant, fine-tuning the representation model can include training a supplementary model (e.g., as described above).

The representation model can optionally be trained using methods as described in U.S. patent application Ser. No. 19/289,470 filed 4 Aug. 2025, which is herein incorporated in its entirety by this reference.

However, the representation model can be otherwise trained.

The method can optionally include determining a biomarker value based on the brain state representation S500, which functions to infer a state of the user from the brain state representation.

The biomarker value can be used to: control an external device (e.g., open an application, close an application, display text, actuate a robotic system, play music, pause music, change music volume, etc.), administer a therapy, send a notification (e.g., to a doctor, to the user), identify a user, and/or for any other suitable use cases.

The biomarker can include a psychological status and/or physiological status. The biomarker is preferably a neurological biomarker (e.g., a neurological state), but can additionally or alternatively include a cardiovascular biomarker and/or any other biomarker for a user. Examples of neurological biomarkers include: mental state (e.g., cognitive state), emotional state (e.g., mood), mental performance, focus level (e.g., attention level), stress level, normal and/or abnormal neurological condition (e.g., epilepsy, Alzheimer's, Parkinson's, neurological deterioration, etc.), eye open and/or closed detection (e.g., blinking detection), response to stimuli, intent, behavior, mental command (e.g., a desired action, text, etc.), text (e.g., thoughts, words the user is reading, etc.), images (e.g., images the user is picturing), brain age, brain development, a comparison metric of the user's neurological state relative to a baseline (e.g., relative to a population baseline, relative to a user's own baseline, etc.), mental command, text, image, emotional state, attention level, neurological disorder state, perceived and/or intended speech, sleep state, depth of anesthesia, fatigue, cognitive state, mental capacities (e.g., learning, memory, familiarity, computation, creativity, etc.), level of education, musical skill, recognition, connectivity, sensory and/or motor disorder states, sensory inputs, development and/or decline of capacities, prediction of future conditions and/or events, preferences, intentions, and/or any other neurological states. The biomarker value can be qualitative, quantitative, relative, discrete, continuous, a classification, numeric, binary, and/or be otherwise characterized.

Determining the biomarker value can optionally include passing the brain state representation to a biomarker model (e.g., a downstream classifier) to output a value for the biomarker. Inputs to the biomarker model can include: the brain state representation (e.g., an embedding and/or segment thereof), supplemental information, and/or any other suitable inputs. The biomarker model can be a decoder (e.g., a trained decoder), a classifier, a foundation model, a combination thereof, and/or any other suitable model. For example, the biomarker model can decode the brain state representation into the biomarker value. The biomarker model can optionally be associated with a biomarker (e.g., the biomarker model is trained using benchmark studies corresponding to the biomarker). In an example, the biomarker model can be selected from a set of trained biomarker models based on a biomarker of interest. The biomarker model can optionally be associated with a specific user (e.g., the biomarker model is fine-tuned using training biosignal data collected for the specific user). S300 can be performed one or more times for a user, one or more times for each of a set of users, and/or any other number of times. In a first variant, the method can include iteratively performing S300 for a given user across time (e.g., to determine a change in the biomarker over time). In a second variant, the method can include determining a value for each of a set of biomarkers for a given user. For example, the method can include: for a first biomarker, determining a first brain state representation (e.g., a first segment of a brain state representation) based on biosignal data collected for a user and the first biomarker (e.g., a mapping of mapping between brain state representation segments and the biomarkers); for a second biomarker, determining a second brain state representation (e.g., a second segment of the brain state representation) based on the biosignal data and the second biomarker; and determining a value for the first biomarker based on the first brain state representation (e.g., using a first biomarker model) and determining a value for the second biomarker based on the second brain state representation (e.g., using a second biomarker model). In a third variant, the method can include performing S300 one or more times for each user in a set of users. In a specific example, S500 can be performed for a first user using a first biosignal device 100 (e.g., with a first number of sensors, with a first sensor positioning, etc.), and performed for a second user using a second biosignal device 100 (e.g., with a second number of sensors, with a second sensor positioning, etc.).

In variants, the output associated with the brain state representation can include generated content. In a first example, a generative model can be conditioned on the brain state representation to generate text, commands, images, and/or other suitable content. In a second example, a stimulus representation (e.g., text, audio, image features, smell, taste, organoleptic response, touch, etc.) can be used to predict a brain response embedding and/or an expected evoked-response pattern, enabling bidirectional mapping between brain signals and stimulus content.

The biomarker value can optionally be determined using methods as described in U.S. patent application Ser. No. 19/289,470 filed 4 Aug. 2025, which is herein incorporated in its entirety by this reference.

However, the biomarker value can be otherwise determined.

### 5. SPECIFIC EXAMPLES

A numbered list of specific examples of the technology described herein are provided below. A person of skill in the art will recognize that the scope of the technology is not limited to and/or by these specific examples.

Specific Example 1. A method for determining a brain state representation of a user, comprising: determining a set of sensor coordinates for each biosignal sensor of a set of biosignal sensors on a head surface of the user and biosignal data measured from each of the set of biosignal sensors; determining a location embedding for the set of biosignal sensors using a location model that ingests the set of sensor coordinates; determining a data embedding for the biosignal data using an input model; determining an input representation based on both the location embedding and the data embedding; and determining the brain state representation based on the input representation using an attention-based model.

Specific Example 2. The method of Specific Example 1, wherein the location embedding comprises a respective location embedding for each biosignal sensor of the set of biosignal sensors, wherein determining the location embedding comprises: for each biosignal sensor of the set of biosignal sensors: determining the sensor coordinates for the respective biosignal sensor based on a universal coordinate system; and generating the respective location embedding for the respective biosignal sensor based on the sensor coordinates for the respective biosignal sensor; wherein, for a first biosignal sensor and a second biosignal sensor of the set of biosignal sensors, a similarity between the respective location embeddings increases as a spatial distance between the sensor coordinates of the first biosignal sensor and the second biosignal sensor decreases.

Specific Example 3. The method of any of Specific Examples 1-2, wherein the set of biosignal sensors comprises a set of electroencephalography (EEG) electrodes, wherein the set of EEG electrodes is arranged according to a standardized electrode placement system selected from the group consisting of a 10-20 system, a 10-10 system, and a 10-05 system.

Specific Example 4. The method of any of Specific Examples 1-3, wherein the attention-based model is trained using training biosignal data by: masking the training biosignal data to generate masked biosignal data; generating a training brain state representation based on the masked biosignal data using the attention-based model; determining reconstructed training biosignal data based on the training brain state representation; removing artifacts from the training biosignal data to determine cleaned biosignal data; and determining a reconstruction loss by comparing the reconstructed training biosignal data to the cleaned biosignal data, wherein the reconstruction loss is used to train the attention-based model.

Specific Example 5. The method of Specific Example 4, wherein determining the reconstruction loss comprises: projecting the cleaned biosignal data and the reconstructed training biosignal data into a structured feature space using a set of convolutional kernels having multiple dilations to generate a projected target biosignal and a projected reconstructed biosignal, respectively; and computing the reconstruction loss between the projected target biosignal and the projected reconstructed biosignal.

Specific Example 6. The method of Specific Example 5, wherein the reconstruction loss maps the reconstructed biosignal and the target biosignal into a component-decomposed space by applying kernels to each, and determines the reconstruction loss in the component-decomposed space.

Specific Example 7. The method of any of Specific Examples 5-6, wherein the reconstruction loss comprises a time-domain loss and a frequency-domain spectral alignment loss based on a Fourier transform.

Specific Example 8. A method for determining a brain state representation of a user, comprising: receiving a biosignal data captured from the user with a biosignal device and a set of sensor coordinates associated with a set of biosignal sensors of the biosignal device positioned on a head surface of the user; determining an input representation based on both the biosignal data and the sensor coordinates using an input model; and determining a brain state representation based on the input representation using a state-space model.

Specific Example 9. The method of Specific Example 8, wherein the input model determines the input representation by projecting the biosignal data to a target space using spatial weights derived from relative sensor coordinates.

Specific Example 10. The method of any of Specific Examples 8-9, wherein the set of biosignal sensors comprises a set of electroencephalography (EEG) electrodes, wherein the set of EEG electrodes is arranged according to a standardized electrode placement system selected from the group consisting of a 10-20 system, a 10-10 system, and a 10-05 system.

Specific Example 11. The method of any of Specific Examples 8-10, wherein the input model: determines a spatial-adaptive input embedding based on the biosignal data and the set of sensor coordinates; and determines the input representation, wherein the input representation comprises the spatial-adaptive input embedding.

Specific Example 12. The method of any of Specific Examples 8-11, wherein determining the input representation comprises projecting the biosignal data from an input montage to a target montage using spatial weights derived from a difference between each sensor coordinate of the set of the sensor coordinates and a standard coordinate from a set of standard coordinates.

Specific Example 13. The method of Specific Example 12, wherein the input representation comprises a spatio-temporal input embedding including a spatial-adaptive input embedding and a temporal-receptive embedding determined using one or more convolutions configured to extract features at multiple temporal resolutions.

Specific Example 14. The method of any of Specific Examples 8-13, wherein the input model encodes the set of sensor coordinates using a sinusoidal function.

Specific Example 15. The method of any of Specific Examples 8-14, wherein the input representation comprises quantile features.

Specific Example 16. The method of any of Specific Examples 8-15, further comprising training the input model using training biosignal data by: masking a portion of the training biosignal data to generate masked biosignal data; determining, using the input model, a training input representation based on the masked biosignal data; determining, using the state-space model, a training brain-state representation based on the training input representation; and training the input model and/or the state-space model based on a loss determined using the training brain-state representation.

Specific Example 17. The method of Specific Example 16, wherein masking at least the portion of the biosignal data comprises temporal semantic random (TSR) masking, and wherein a masking ratio increases during training.

Specific Example 18. The method of Specific Example 17, wherein the TSR masking comprises: selecting the masking ratio that defines a number of time steps to remain unmasked; and randomly determining a position and a length for each of a plurality of temporal blocks to be preserved as unmasked biosignal data, wherein the temporal blocks are non-overlapping and have variable lengths, and wherein time steps outside the plurality of temporal blocks are masked as the masked biosignal data.

Specific Example 19. A system for determining a brain state representation, comprising: a biosignal device comprising a set of biosignal sensors configured to measure biosignal data, wherein each biosignal sensor is associated with a sensor coordinate; and a computing system communicatively coupled to the biosignal device and configured to: receive the biosignal data measured using the set of biosignal sensors and the set of sensor coordinates associated with the set of biosignal sensors; determine an input representation using at least one of: a first input-representation generation mode, wherein the computing system is configured to: determine, using a location model, a location embedding based on the set of sensor coordinates; determine, using a first input model, a data embedding based on the biosignal data; and determine the input representation based on the location embedding and the data embedding; and a second input-representation generation mode, wherein the computing system is configured to: determine, using a second input model, the input representation based jointly on the biosignal data and the set of sensor coordinates; and determine, using a trained brain-state representation model, the brain state representation based on the input representation.

Specific Example 20. The system of Specific Example 19, wherein the trained brain-state representation model comprises an attention-based model and/or a state-space model.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken lines in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for determining a brain state representation of a user, comprising:
determining a set of sensor coordinates for each biosignal sensor of a set of biosignal sensors on a head surface of the user and biosignal data measured from each of the set of biosignal sensors;
determining a location embedding for the set of biosignal sensors using a location model that ingests the set of sensor coordinates;
determining a data embedding for the biosignal data using an input model;
determining an input representation based on both the location embedding and the data embedding; and
determining the brain state representation based on the input representation using an attention-based model.

2. The method of claim 1, wherein the location embedding comprises a respective location embedding for each biosignal sensor of the set of biosignal sensors, wherein determining the location embedding comprises:
for each biosignal sensor of the set of biosignal sensors:
determining the sensor coordinates for the respective biosignal sensor based on a universal coordinate system; and
generating the respective location embedding for the respective biosignal sensor based on the sensor coordinates for the respective biosignal sensor;
wherein, for a first biosignal sensor and a second biosignal sensor of the set of biosignal sensors, a similarity between the respective location embeddings increases as a spatial distance between the sensor coordinates of the first biosignal sensor and the second biosignal sensor decreases.

3. The method of claim 1, wherein the set of biosignal sensors comprises a set of electroencephalography (EEG) electrodes, wherein the set of EEG electrodes is arranged according to a standardized electrode placement system selected from the group consisting of a 10-20 system, a 10-10 system, and a 10-05 system.

4. The method of claim 1, wherein the attention-based model is trained using training biosignal data by:
masking the training biosignal data to generate masked biosignal data;
generating a training brain state representation based on the masked biosignal data using the attention-based model;
determining reconstructed training biosignal data based on the training brain state representation;
removing artifacts from the training biosignal data to determine cleaned biosignal data; and
determining a reconstruction loss by comparing the reconstructed training biosignal data to the cleaned biosignal data, wherein the reconstruction loss is used to train the attention-based model.

5. The method of claim 4, wherein determining the reconstruction loss comprises:
projecting the cleaned biosignal data and the reconstructed training biosignal data into a structured feature space using a set of convolutional kernels having multiple dilations to generate a projected target biosignal and a projected reconstructed biosignal, respectively; and
computing the reconstruction loss between the projected target biosignal and the projected reconstructed biosignal.

6. The method of claim 5, wherein the reconstruction loss maps the reconstructed biosignal and the target biosignal into a component-decomposed space by applying kernels to each, and determines the reconstruction loss in the component-decomposed space.

7. The method of claim 5, wherein the reconstruction loss comprises a time-domain loss and a frequency-domain spectral alignment loss based on a Fourier transform.

8. A method for determining a brain state representation of a user, comprising:
receiving a biosignal data captured from the user with a biosignal device and a set of sensor coordinates associated with a set of biosignal sensors of the biosignal device positioned on a head surface of the user;
determining an input representation based on both the biosignal data and the sensor coordinates using an input model; and
determining a brain state representation based on the input representation using a state-space model.

9. The method of claim 8, wherein the input model determines the input representation by projecting the biosignal data to a target space using spatial weights derived from relative sensor coordinates.

10. The method of claim 8, wherein the set of biosignal sensors comprises a set of electroencephalography (EEG) electrodes, wherein the set of EEG electrodes is arranged according to a standardized electrode placement system selected from the group consisting of a 10-20 system, a 10-10 system, and a 10-05 system.

11. The method of claim 8, wherein the input model:
determines a spatial-adaptive input embedding based on the biosignal data and the set of sensor coordinates; and
determines the input representation, wherein the input representation comprises the spatial-adaptive input embedding.

12. The method of claim 8, wherein determining the input representation comprises projecting the biosignal data from an input montage to a target montage using spatial weights derived from a difference between each sensor coordinate of the set of the sensor coordinates and a standard coordinate from a set of standard coordinates.

13. The method of claim 12, wherein the input representation comprises a spatio-temporal input embedding including a spatial-adaptive input embedding and a temporal-receptive embedding determined using one or more convolutions configured to extract features at multiple temporal resolutions.

14. The method of claim 8, wherein the input model encodes the set of sensor coordinates using a sinusoidal function.

15. The method of claim 8, wherein the input representation comprises quantile features.

16. The method of claim 8, further comprising training the input model using training biosignal data by:
masking a portion of the training biosignal data to generate masked biosignal data;
determining, using the input model, a training input representation based on the masked biosignal data;
determining, using the state-space model, a training brain-state representation based on the training input representation; and
training the input model and/or the state-space model based on a loss determined using the training brain-state representation.

17. The method of claim 16, wherein masking at least the portion of the biosignal data comprises temporal semantic random (TSR) masking, and wherein a masking ratio increases during training.

18. The method of claim 17, wherein the TSR masking comprises:
selecting the masking ratio that defines a number of time steps to remain unmasked; and
randomly determining a position and a length for each of a plurality of temporal blocks to be preserved as unmasked biosignal data, wherein the temporal blocks are non-overlapping and have variable lengths, and wherein time steps outside the plurality of temporal blocks are masked as the masked biosignal data.

19. A system for determining a brain state representation, comprising:
a biosignal device comprising a set of biosignal sensors configured to measure biosignal data, wherein each biosignal sensor is associated with a sensor coordinate; and
a computing system communicatively coupled to the biosignal device and configured to:
receive the biosignal data measured using the set of biosignal sensors and the set of sensor coordinates associated with the set of biosignal sensors;
determine an input representation using at least one of:
a first input-representation generation mode, wherein the computing system is configured to:
determine, using a location model, a location embedding based on the set of sensor coordinates;
determine, using a first input model, a data embedding based on the biosignal data; and
determine the input representation based on the location embedding and the data embedding; and
a second input-representation generation mode, wherein the computing system is configured to:
determine, using a second input model, the input representation based jointly on the biosignal data and the set of sensor coordinates; and
determine, using a trained brain-state representation model, the brain state representation based on the input representation.

20. The system of claim 19, wherein the trained brain-state representation model comprises an attention-based model and/or a state-space model.
